(19) United States
(12) Patent Application Publication
(10) Pub. No.: US 2010/0296216 A1
(43) Pub. Date: Nov. 25, 2010

(54) PROTECTIVE DEVICE AND COMBINATION SWITCHING DEVICE

(75) Inventors: Ruediger SCHWEITZER, Neulussheim (DE); Richard Kommert, Heidelberg (DE); Klaus Wittmann, Nussloch (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/819,612

(22) Filed: Jun. 21, 2010

Related U.S. Application Data
(63) Continuation of application No. PCT/EP2008/010868, filed on Dec. 18, 2008.

(30) Foreign Application Priority Data
Dec. 21, 2007 (DE) 10 2007 062 987.9

(51) Int. Cl. H02H 3/00

(52) U.S. Cl. 361/87

(57) ABSTRACT

The disclosure relates to a protective device, for example an overload relay, for attaching the same to a switching device, such as a contactor. The housing wall of the protective device has at least one first and one second recess each on a first side facing the switching device, and on a second side facing away from the switching device, and the recesses are connected to each other such that the switching device is accessible through the recesses for the purpose of connecting a terminal lead.

### RELATED APPLICATIONS

This application claims priority as a continuation application under 35 U.S.C. §120 to PCT/EP2008/010868, which was filed as an International Application on Dec. 18, 2008 designating the U.S., and which claims priority to German Application 10 2007 062 987.9 filed in Germany on Dec. 21, 2007. The entire contents of these applications are hereby incorporated by reference in their entireties.

### FIELD

The disclosure relates to a protective device, such as an overload relay for attachment to a switching device, for example, a contactor.

The disclosure also relates to a combination switching device having a switching device, such as a contactor, and a protective device attached to it, for example, an overload relay.

### BACKGROUND INFORMATION

A protective device may be a thermal or electronic overload relay which can be joined to a switching device in the form of a contactor to form a device combination. A protective device of this type can have an insulating-material housing, including a front face, a first and a second narrow face, a first and a second broad face, and an attachment face.

During the assembly of known switching device combinations including a switching device and a protective device, for example, in the case of combinations of contactors with thermal and/or electronic relays, it can be difficult to connect a connecting conductor to a terminal which is located between the switching device and the protective device. For example, it can be difficult to connect a connecting conductor to a coil connecting terminal or to an auxiliary contact terminal of the contactor, in a simple manner, because these terminals can be located between the devices, and access to them can be difficult.

In known combinations, a relatively long distance can therefore often be provided between the protective device and the switching device. By way of example, EP 0 774 768 A1 discloses one such switching device combination. There, a gap can be left between the switching device and the protective device combination in order to allow access to the connecting terminals for the switching device, which can be located on that housing face of the switching device which faces the protective device.

Known switching device combinations include an additional terminal on the protective device, for example, the thermal and/or electronic relay, where a conductor piece can be looped through to the inaccessible connecting terminal on the switching device. The inaccessible connecting terminal on the switching device can be in this case, located at a point where it is accessible on the switching device. This can have the disadvantage that the additional terminal and the looped-through conductor end result in additional costs. Furthermore, this can complicate installation for the fitter on site because, for example, he must close two terminals when making the coil connection.

Other known switching device combinations include a coil connecting terminal arranged obliquely on a contactor and projecting somewhat from a housing, in order to make the coil connection more accessible. Although this can simplify accessibility, when the conductor then passes over the side of the device, physical space for further switching devices can be lost.

### SUMMARY

The disclosure relates to a protective device for attachment to a switching device, comprising: a housing wall; at least one first and second recess on a first face of the housing wall for facing the switching device; and at least one first and second recess on a second face, for facing away from the switching device, wherein the recesses of the first and second faces are connected to one another for accessing the switching device through the recesses for connection of a connecting conductor.

### BRIEF DESCRIPTION OF THE DRAWINGS

The disclosure will be explained in more detail in the following text with reference, by way of example, to the attached drawings, in which:

FIG. 1 shows a schematic illustration of a first exemplary embodiment of a switching device combination according to the disclosure, having a switching device and a protective device fitted to it;

FIG. 2 shows a schematic illustration of a second exemplary embodiment of a switching device combination according to the disclosure, having a switching device and a protective device fitted to it;

FIG. 3 shows the exemplary embodiment of the protective device shown in FIG. 1, viewed from the connecting face; and

FIG. 4 shows the exemplary embodiment of the protective device shown in FIG. 2, viewed from the connecting face.

### DETAILED DESCRIPTION

The disclosure provides a protective device, for example, an overload relay, for attachment to a switching device, such as a contactor, such that good accessibility to connecting terminals on that face of the switching device which faces the protective device can be provided with only a short distance between the protective device and the switching device.

An aspect of the disclosure is that the housing wall of the protective device, respectively, can have at least one first and second recess on a first face, which faces the switching device, and on a second face, which faces away from the switching device. The recesses can be connected to one another such that the switching device can be accessible through the recesses for connection of a connecting conductor.

In an exemplary embodiment of the protective device, when the protective device is connected to the switching device to form a combination switching device, a connecting terminal on that face of the switching device which faces the protective device can still be accessible through the two recesses and their connection from that face of the protective device which faces away from the switching device, without occupying any additional physical space and without having to fit an additional part to the protective device. A connecting conductor, for example, to a coil connection of a contactor, to which an overload relay can be fitted, can therefore be passed through the recesses in the housing wall of the overload relay to the connecting terminal for the contactor, and can be screwed tight there.

The first and second recesses can be connected by a channel which can be in the form of a groove and can run at least partially in the housing wall of the protective device. “In the form of a groove” means that the connecting channel can be externally open on one of its longitudinal faces.

“Runs at least partially in the housing wall” means that at least one boundary wall, which runs in the longitudinal extent direction, of the channel which can be in the form of a groove, can be formed by the housing. The phrase “channel in the form of a groove” is also intended, according to the disclosure, to cover a channel which can be open on two longitudinal faces. The surface geometry of a channel which is open on two faces can also appear as a step in the housing surface, which runs in the longitudinal extent direction of the channel.

In the case of contactors which have the coil connections arranged on the same plane as the main connections, this can be achieved by a simple refinement of a connecting channel by flattening a subarea of the upper area of the overcurrent relay in which the connecting terminals of the auxiliary contacts are located.

The connecting terminals of the auxiliary contacts can need to be placed closer to one another for this purpose, than in known arrangements. At the same time, for good accessibility to the coil connecting terminal, the connecting channel can offer the capability for the connected coil wire to be routed along this channel.

By way of example, an overload relay according to the disclosure can be attached by one of its narrow faces to a narrow face of a contactor. The connecting terminal of the contactor, which is intended to remain accessible, for example, the coil connecting terminal of the contactor, can be located on that narrow face of the contactor to which the relay is attached. The first recess can be located in the housing wall of the overload relay, at the same height as the connecting opening on the contactor. The second recess can be located on the second narrow face of the housing of the overload relay, which faces away from the connecting opening. In one exemplary embodiment of the disclosure, the channel which is in the form of a groove then runs in the front face of the overload relay, and connects the two recesses. According to the disclosure, this physical geometric refinement of the overload relay means that, despite the distance between the protective device and the switching device in the device combination being relatively short, good accessibility can be provided to the connecting opening, for example, of the coil connection to the contactor, in the intermediate space between the devices.

This can be developed in various ways in further exemplary embodiments, corresponding to the various types of protective device design.

According to one exemplary embodiment of the disclosure, the cross-sectional area of the first recess can be greater than the cross-sectional area of the channel, and the channel widens toward the first recess. By way of example, the channel may be widened by an incline. For example, the first recess may be sufficiently large that it covers two or more connecting openings, located alongside one another, on the switching device, for example, a coil connection and one or more auxiliary contact connections. One or more connecting conductors can therefore be passed to one or more connecting openings through the channel, as required.

This embodiment can be useful, for example, for miniature contactors which, in addition to the main connections and the coil connection, can also have auxiliary contacts on the same plane, because their accessibility can then be achieved in a simple manner by an additional incline at the end of the connecting channel.

In the case of switching devices, for example, in the case of contactors, in which the coil connecting terminals are located on a lower level than the main connecting terminals, better accessibility to these coil connections can be achieved, according to the disclosure, by inclining the relay to the level of the coil connecting terminal in the region of the corner where the position of the coil connection is located. Once again, the connecting channel provided according to the disclosure allows the coil connecting cable to be laid without physical space being lost by passing this cable over it at the side. This exemplary embodiment can include the first recess in the housing wall widens at right angles to the longitudinal extent direction of the channel.

In another exemplary embodiment, the two exemplary embodiments described above can be combined. A protective device designed in this way can be arranged such that the first recess in the housing wall widens in two directions, wherein the directions of the widened areas run at right angles to the longitudinal extent direction of the channel on the plane of the first face of the housing wall which faces the switching device.

All other implementation options which are familiar to a person skilled in the art on the basis of the disclosure of the functions according to the disclosure described here are, of course, also intended to be covered within the context of equivalence of the disclosure.

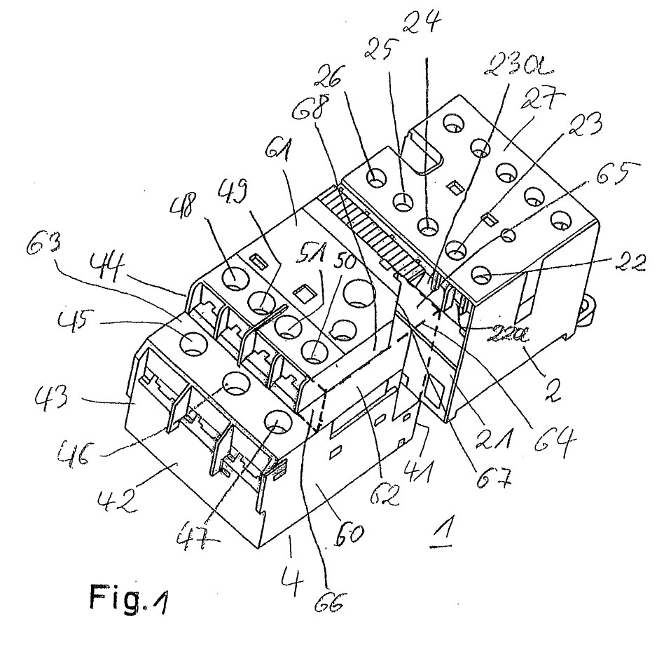

FIG. 1 shows a combination switching device 1 having a miniature contactor 2 and an overload relay 4 attached to it. On its first housing face 41, also referred to as the first narrow face, the overload relay 4 can be connected to the connecting face 21, also referred to as the narrow face, of the contactor 2. The distance between the contactor 2 and the overload relay 4 can be short, and the two can be located close to one another, thus resulting in a slimline design which occupies little space. The circumferential contour of the first narrow face 41 of the overload relay 4 can be approximately the same as the circumferential contour of the connecting face 21 of the contactor.

On its upper housing face 27, the contactor 2 has openings for operation of screw connecting terminals. The openings 24, 25, 26 can be associated with the phase connections. The opening 23 can be associated with an auxiliary contact, and the opening 22 can be associated with the coil connection. The phase connecting terminals and the auxiliary contact and coil connecting terminals can be arranged on one plane.

The first housing face 41 of the overload relay 4 has a second housing face 42, also referred to as a second narrow face, opposite it. This face can be stepped, thus resulting in a front narrow face 43 and a rear narrow face 44. Three connecting openings with the associated terminal operating openings 45, 46, 47 for the connection of the phase conductors can be provided on the front narrow face 43, and two pairs 48, 49; 50, 51 of connecting openings with the associated terminal operating openings for connection of auxiliary contacts can be provided on the rear narrow face 44.

In the vicinity of the edge with the longitudinal face 60, a channel 62 which can be in the form of a groove is introduced in the rear front face 61 of the housing of the overload relay 4, and its base runs at the same height as the front front face 63 of the housing. The channel 62 can be open toward the longitudinal face 60, as a result of which it is also possible to speak of a stepped contour.

The dashed-line contour lines 64 indicate the profile of the housing contour if the channel 62, which can be in the form of a groove, were not present. In this case, if the housing had the contour indicated by the dashed line, it can be seen that the first narrow face 41 of the overload relay 4 can cover the narrow face 21 of the contactor 2, over the entire width of the narrow face. Access would then no longer be possible to the coil connection 22a and the auxiliary contact connection 23a on the contactor 2.

The channel 62, which can be in the form of a groove, results in a first recess 65 being formed on the first narrow face 41 of the overload relay, at the same height as the coil connecting opening 22a and the auxiliary contact connecting opening 23a of the contactor, and in a second recess 66 being formed on the rear narrow face 44. The two recesses 65, 66 can be connected by the channel 62 which can be in the form of a groove. The first recess 65 can have a larger area than the second recess 66. This can be achieved by an incline 67 in the internal wall 68 of the channel 62 which can be in the form of a groove. The coil connecting opening 22a and the auxiliary contact connecting opening 23a of the contactor 2 can now be accessible from the second recess 66 through the channel 62, which can be in the form of a groove, and the first recess 65. In this case, there is no requirement for any further space outside the circumferential contour of the combination switching device 1, for example in order to make it possible to connect a connecting conductor to the coil connecting opening 22a or the auxiliary contact connecting opening 23a of the contactor 2.

The internal design and the arrangement of the internal components and assemblies of the overload relay 4 according to the disclosure can be left essentially the same as in the case of an overload relay without the recesses according to the disclosure and the channel according to the disclosure, for example, if the housing contour were to correspond to the dashed-line contour 64. A difference is that the auxiliary contact connecting openings 48, 49, 50, 51 can be moved toward one another so as to provide sufficient space for the recess 66 on the rear narrow face 44.

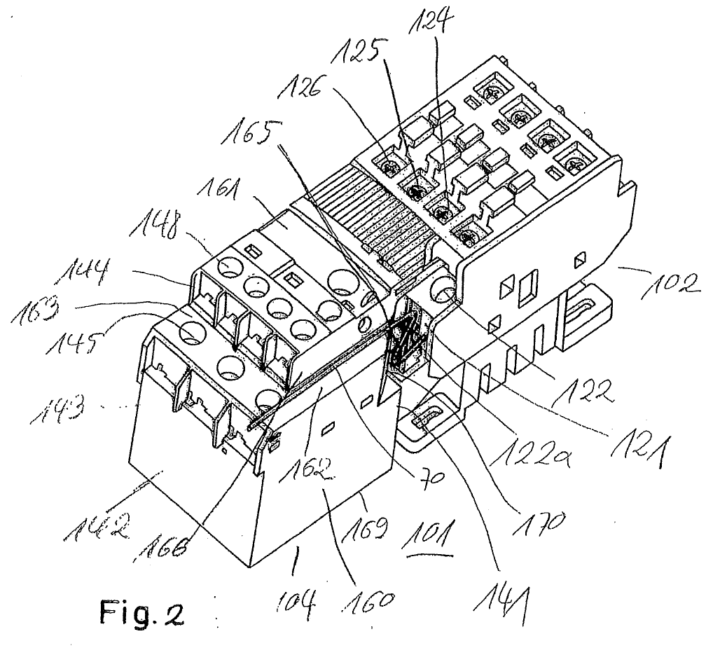

FIG. 2 will now be considered. This shows an exemplary embodiment of a combination switching device 101 having a contactor 102 and an overload relay 104 attached to it. The parts or assemblies correspond to those described in conjunction with FIG. 1, and identical or similar elements or assemblies are annotated in FIG. 2 with the same reference numbers as in FIG. 1 but increased by 100.

In the case of the contactor 102 shown in FIG. 2, the coil connecting terminal 122a can be arranged at a lower level than the phase connections 124, 125, 126. The first recess 165 in the first narrow face 141 of the overload relay 104 widens at right angles to the longitudinal extent direction of the channel 162, which can be in the form of a groove, and in the direction of the attachment face 169 of the housing of the overload relay 104. This can be achieved by an incline 170 on the edge which can be formed at the junction between the first narrow face 141 and the longitudinal face 160 of the housing. Therefore, the first recess 165 can form a second channel, which runs vertically downward, toward the coil connection. FIG. 2 shows a connecting conductor 70 which can be connected to the coil connection 122a of the contactor 102 and can be routed in the first recess 165 and the channel 162, which can be in the form of a groove, toward the second narrow face 142 of the housing of the overload relay 104.

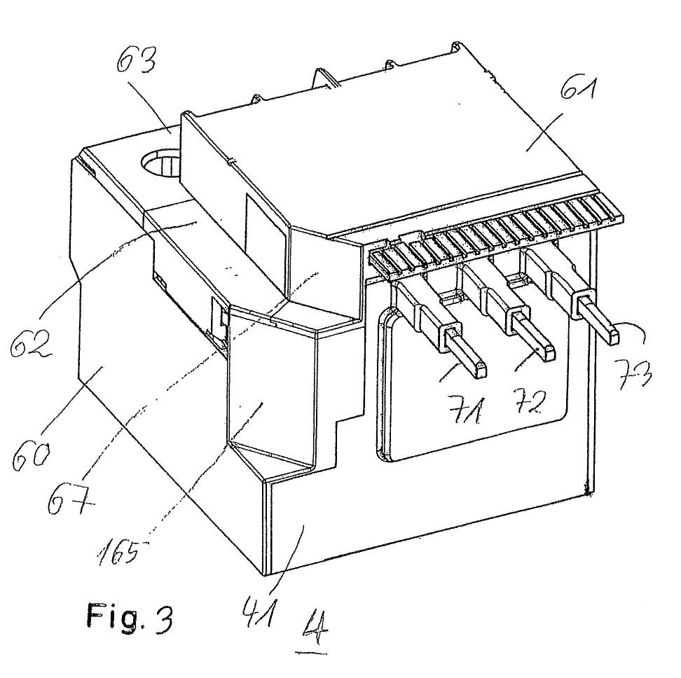

FIG. 3 shows a view of the first narrow face 41 of an overload relay 4 as is used in the combination switching device 1 shown in FIG. 1. The parts or assemblies correspond to those described in conjunction with FIG. 1, and have the same reference numbers. The figure shows the three connection pins 71, 72, 73 by which the overload relay can be attached to the phase connecting terminals of a contactor. The figure also shows the channel 62 which can be in the form of a groove, the incline 67 which can allow access to the coil and auxiliary connecting terminals of a contactor which can be located at the same height as the phase connecting terminals. Furthermore, the overload relay as shown in FIG. 3 also has a second, vertically running channel, which can be formed by the vertical extension of the first recess 165 at the edge, as has been described in conjunction with the exemplary embodiment shown in FIG. 2, and which can allow access to a coil connecting terminal which can be arranged on the relay on a level below the phase connecting terminals.

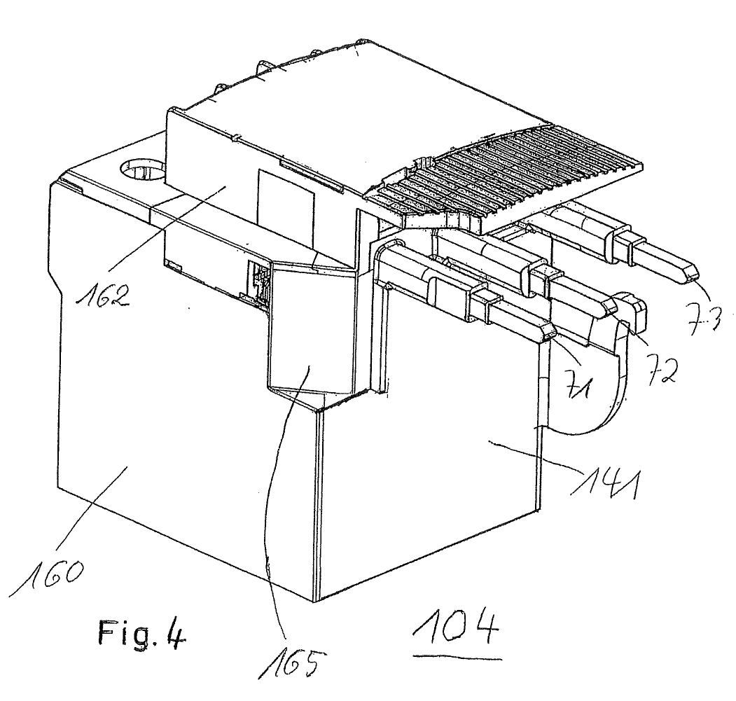

FIG. 4 shows a view of the first narrow face 141 of an overload relay 104, as can be used in the combination switching device 101 according to and as described in conjunction with FIG. 2. The parts or assemblies correspond to those described in conjunction with FIG. 2, and have the same reference numbers. The overload relay can be designed with a horizontally running channel 162, which can be in the form of a groove, and a vertical channel 165 which runs on the edge which the first narrow face 141 forms with the longitudinal face 160.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

| | |
|---|---|
| 1 | Combination switching |
| | device |
| 2 | Miniature contactor, |
| | switching device |
| 4 | Overload relay, protective |
| | device |
| 21 | Connecting face of the |
| | contactor |
| 22 | Coil connection |
| 22a | Coil connecting opening |
| 23 | Auxiliary contact connection |
| 23a | Auxiliary contact connecting |
| | opening |
| 24 | Phase connection |
| 25 | Phase connection |
| 26 | Phase connection |
| 27 | Upper housing face |
| 41 | First housing face, narrow |
| | face relay |
| 42 | Second housing face, |
| | narrow face relay |
| 43 | Front narrow face |
| 44 | Rear narrow face |
| 45 | Phase connecting opening |
| 46 | Phase connecting opening |
| 47 | Phase connecting opening |
| 48 | Auxiliary contact connecting |
| | opening |
| 49 | Auxiliary contact |
| | connecting opening |
| 50 | Auxiliary contact |
| | connecting opening |
| 51 | Auxiliary contact |
| | connecting opening |
| 60 | Longitudinal face |
| 61 | Rear front face |
| 62 | Channel in the form of a |
| | groove |
| 63 | Front front face |
| 64 | Dashed-line housing |
| | contour |
| 65 | First recess |
| 66 | Second recess |
| 67 | Incline |
| 68 | Internal wall |
| 70 | Connecting conductor |
| 71 | Connection pin |
| 72 | Connection pin |
| 73 | Connection pin |
| 101 | Combination switching |
| | device |
| 102 | Miniature contactor, |
| | switching device |
| 104 | Overload relay, protective |
| | device |
| 121 | Connecting face of the |
| | contactor |
| 122 | Coil connection |
| 122a | Coil connecting opening |
| 124 | Phase connection |
| 125 | Phase connection |
| 126 | Phase connection |
| 141 | First housing face, narrow |
| | face relay |
| 142 | Second housing face, |
| | narrow face relay |
| 143 | Front narrow face |
| 144 | Rear narrow face |
| 145 | Phase connecting opening |
| 148 | Auxiliary contact |
| | connecting opening |
| 160 | Longitudinal face |
| 161 | Rear front face |
| 162 | Channel in the form of a |
| | groove |
| 163 | Front front face |
| 165 | First recess |
| 166 | Second recess |
| 169 | Attachment face |
| 170 | Incline |

What is claimed is:

1. A protective device for attachment to a switching device, comprising:
a housing wall;
at least one first and second recess on a first face of the housing wall for facing the switching device;
at least one first and second recess on a second face of the housing wall for facing away from the switching device, wherein the recesses of the first and second face are connected to one another for accessing the switching device through the recesses for connection of a connecting conductor.

2. The protective device as claimed in claim 1, wherein the first and second recesses are connected by a channel formed as a groove that runs at least partially in the housing wall of the protective device.

3. The protective device as claimed in claim 2, wherein a cross-sectional area of the first recess is greater than a cross-sectional area of the channel, and wherein the channel widens toward the first recess.

4. The protective device as claimed in claim 2, wherein the first recess in the housing wall widens at right angles to a longitudinal extent direction of the channel.

5. The protective device as claimed in claim 4, wherein the first recess in the housing wall widens in two directions, wherein the directions of the widened areas run at right angles to the longitudinal extent direction of the channel on a plane of the first face of the housing wall.

6. A switching device in combination with the protective device as claimed in claim 1, the protective device being attached to the switching device.

7. The protective device as claimed in claim 1, wherein the protective device is an overload relay.

8. The combination switching device as claimed in claim 6, wherein the first and second recesses are connected by a channel formed as a groove that runs at least partially in the housing wall of the protective device.

9. The combination switching device as claimed in claim 8, wherein a cross-sectional area of the first recess is greater than a cross-sectional area of the channel, and wherein the channel widens toward the first recess.

10. The combination switching device as claimed in claim 8, wherein the first recess in the housing wall widens at right angles to a longitudinal extent direction of the channel.

11. The combination switching device as claimed in claim 10, wherein the first recess in the housing wall widens in two directions, wherein the directions of the widened areas run at right angles to the longitudinal extent direction of the channel on a plane of the first face of the housing wall.
